(19) United States
(12) Patent Application Publication
(10) Pub. No.: US 2015/0240895 A1
(43) Pub. Date: Aug. 27, 2015

(54) SYSTEM FOR ABRASION WARNING OF BRAKE FRICTION PAD USING ESC SYSTEM

(71) Applicant: Hyundai Motors Company, Seoul (KR)

(72) Inventor: Ju-Hoon SHIN, Suwon-Shi (KR)

(73) Assignee: Hyundai Motors Company, Seoul (KR)

(21) Appl. No.: 14/550,977

(22) Filed: Nov. 22, 2014

(30) Foreign Application Priority Data
Feb. 25, 2014 (KR) 10-2014-21949

(51) Int. Cl. F16D 66/02

(52) U.S. Cl. CPC F16D 66/022

(57) ABSTRACT

Disclosed are system and method for abrasion warning of a brake friction pad of a vehicle. The system may include a friction pad abrasion sensing system (ESC) including a pressure sensor. The ESC system may recognize a speed change in association with a wheel speed sensor of the vehicle, measure a braking pressure using the pressure sensor included in the ESC system when the vehicle is decelerated, calculate and accumulate an abrasion index proportional to the measured braking pressure, and generate and output a notification message when the accumulated abrasion index is more than a predetermined reference value.

### CROSS-REFERENCE TO RELATED APPLICATIONS

The present application claims priority of Korean Patent Application Number 10-2014-21949 filed on Feb. 25, 2014, the entire contents of which application are incorporated herein for all purposes by this reference.

### BACKGROUND OF INVENTION

1. Field of Invention

The present invention relates to a system for abrasion warning of a brake friction pad using a friction pad abrasion sensing system (ESC), and more particularly, to a technology that automatically detects a replacement timing of a friction pad of a brake system and notifies the friction pad replacement timing to a driver without adding a separate additional device by using an electronic control logic of the ESC system installed in a vehicle.

2. Description of Related Art

In general, a friction pad applied to a brake system of an automobile is provided to stop a vehicle by friction force and since the brake pad uses the friction force every braking, the brake pad is inevitably abraded. Accordingly, when the brake pad is worn by the abrasion, the friction force deteriorates, and as a result, since a braking capability deteriorates, replacement of the brake pad with a new brake pad is periodically required.

A replacement cycle of the known brake pad is generally clarified in an owner manual of a corresponding vehicle, but the pad replacement cycle depends on a driving habit of the driver and a usual travelling state.

Therefore, in general, a clip type pin is mounted on a pad back plate with a gap separated from a brake disk surface as illustrated in FIGS. 1A-1C in the vehicle. In this case, when the pin and the disk eventually contact each other and squeaky noise is generated in driving while the pad is abraded and the gap between the pin and the disk surface is gradually decreased, the driver recognizes a pad replacement timing.

As illustrated in FIGS. 1A-1C, a known method that notifies the pad replacement timing through sound generated when the clip type pin contacts the disk surface may induce the driver to replace the pad through sound, but the disk surface is continuously damaged due to a clip caused by friction, and as a result, even the disk needs to be replaced in addition to the pad. Accordingly, when even the damaged disk is replaced at the time of replacing the pad, replacement work cost and cost for parts including the pad and the disk for replacement are additionally incurred, and as a result, total cost is increased.

When the damaged disk is not replaced in order to prevent the increase of the cost, a disk thickness variation (DTV) of the disk surface is influenced, which exerts a large influence on a judder problem which occurs in braking.

Meanwhile, as other known method for recognizing the abrasion of the pad, a method that directly senses the abrasion of the pad by adding a pad abrasion recognition sensing device is known.

FIG. 2 illustrates the known pad abrasion recognition sensing device. The pad abrasion recognition sensing device is usually applied to a luxury vehicle, and is configured in such a manner that the pad replacement timing is converted into an electric signal by adding an electric sensing device to a pad back plate to allow the driver to recognize the pad replacement timing through a replacement guidance message.

However, since the known pad abrasion recognition sensing device is configured by adding the electric device to the pad, the cost is increased, and as a result, the known pad abrasion recognition sensing device is not suitable to apply to a general small vehicle.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention is contrived to solve the above-identified and/or other problems, and the present invention has been made in an effort to automatically calculate a friction pad replacement timing of a brake system without adding a separate additional device by using an electronic control unit (ECU) control logic of a friction pad abrasion sensing system (ESC) installed in a vehicle and notify the calculated friction pad replacement timing to a driver according to the friction pad replacement timing to improve convenience for the driver.

Various aspects of the present invention provide a system for abrasion warning of a brake friction pad of a vehicle. The system may include an ESC system which include a pressure sensor, wherein the ESC system may recognize a speed change in association with a wheel speed sensor of the vehicle, measure a braking pressure using the pressure sensor included in the ESC system when the vehicle is decelerated, calculate and accumulate an abrasion index proportional to the measured braking pressure, and generate and output a notification message when the accumulated abrasion index is more than a predetermined reference value.

The ESC system may further receive vehicle outdoor temperature sensor information from a vehicle outdoor temperature sensor, and grant and apply a first weight to calculation of the abrasion index if it is judged that a vehicle outdoor temperature is in a hot rolling state.

The ESC system may further receive at least one of a rain sensor signal from a rain sensor and a wiper operation signal from a vehicle body control unit, and grant and apply a second weight to the calculating of the abrasion index in accord with the received rain sensor signal or the received wiper operation signal or both.

The ESC system may further receive at least one of a steering control signal from a Motor-Driven Power Steering (MDPS) system and yaw sensor information from a YAW sensor, judge if the vehicle is turned based on the received steering control signal or the YAW sensor information or both, and grant and apply a third weight to the calculating of the abrasion index if it is judged that the vehicle is turned.

The ESC system may further receive suspension height sensor information from a suspension height sensor, judge if a load of the vehicle increases based on the suspension height sensor information, and grant and apply a fourth weight to the calculating of the abrasion index if it is judged that the load of the vehicle increases.

The ESC system may further receive longitudinal G sensor information from a longitudinal G sensor of the vehicle, judge whether the vehicle is in a steel traveling state based on the longitudinal G sensor information, and grant and apply a fifth weight to the calculating of the abrasion index if it is judged that the vehicle is in the steel traveling state.

The ESC system may further receive a brake lamp signal from a brake system of the vehicle, and grant and apply a sixth weight to the calculating of the abrasion index if it is judged that repeated braking is performed within a set time based on the brake lamp signal.

Various other aspects of the present invention provide a method using the ESC system of the present invention for abrasion warning of a brake friction pad of a vehicle.

The present invention provides several effects or advantageous including the following.

Improvement of merchantability and performance. A replacement timing of a brake friction pad is continuously monitored through an ESC system previously provided in a vehicle and a notification message is provided to replace the brake friction pad in advance before a brake part is damaged by abrasion of the brake friction pad to improve convenience and improve resulting vehicle merchantability.

Saving of cost and weight. The present invention is configured in such a manner that the replacement timing of the brake friction pad is monitored through the ESC system previously provided in the vehicle, and as a result, a separate additional means for monitoring the abrasion of the brake friction pad is not required. Therefore, the abrasion of the brake friction pad can be monitored without an increase of manufacturing cost of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A, FIG. 1B, and FIG. 1C illustrate a known pad abrasion recognition mechanism in which a clip type pin is mounted on a pad back plate with a gap separated from a brake disk surface.

FIG. 2 illustrates a known pad abrasion recognition sensing device.

FIG. 3 is a block diagram illustrating an exemplary system which includes an ESC system for abrasion warning of a brake friction pad according to the present invention.

FIG. 4 is a flowchart illustrating an exemplary process of calculating an abrasion amount of the brake friction pad using the ESC system according to the present invention.

FIG. 5A, FIG. 5B, FIG. 5C, and FIG. 5D illustrates examples of a notification message displayed on a cluster of a vehicle to inform a brake friction pad replacement timing.

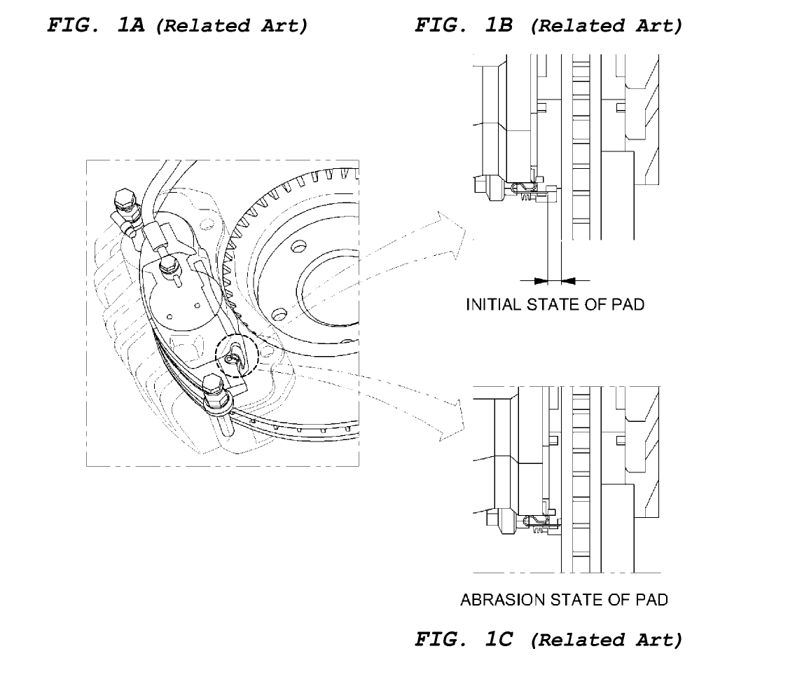

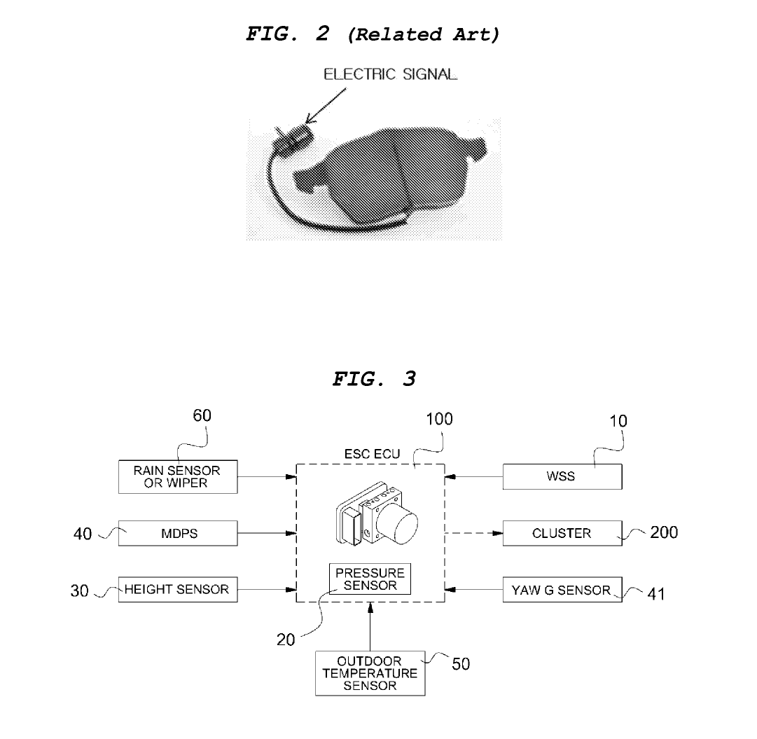

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a technology that automatically calculates a replacement timing of a brake friction pad provided in a brake system of a vehicle and notifies the replacement timing to a driver, and that automatically calculates a replacement timing of a friction pad of a brake system and notifies the friction pad replacement timing to a driver by using an ECU control logic of a friction pad abrasion sensing system (ESC) according to a tendency in which an ESC system is mounted in a vehicle.

FIG. 3 is a block diagram illustrating a system for abrasion warning of a brake friction pad using an ESC system according to various embodiments of the present invention. As illustrated in FIG. 3, the system for abrasion warning of a brake friction pad includes an ESC system 100 of the present invention that is connected with a wheel speed sensor 10, a pressure sensor 20, a suspension link height sensor 30, an MDPS 40, a yaw rate/lateral g-sensor (YAW-G sensor) 41, an outdoor temperature sensor 50 and/or a rain sensor or a wiper 60 provided in the vehicle to receive sensing information and operation information from the listed respective devices and judge an abrasion amount of the brake friction pad based on the received information.

The ESC system 100 is configured to calculate an abrasion index of the brake friction pad through information received from one or more devices of the respective devices and notify a driver to replace the brake friction pad when an accumulation value of the abrasion index is larger than a predetermined reference value, for example, a friction pad abrasion specification (e.g., abrasion SPEC or Z).

Basically, the ESC system 100 is configured to recognize a velocity change rate in association with a wheel speed sensor (hereinafter, WSS) 10 of the vehicle, judge whether the vehicle is decelerated/accelerated through the recognized velocity change rate to recognize vehicle braking, measure braking pressure from the pressure sensor 20 included in the ESC system 100 when the vehicle is braked, calculate and accumulate the abrasion index in proportion to the measured braking pressure, and generate and output a notification message when the accumulated abrasion index is larger than the predetermined reference value.

The deceleration of the vehicle may be generally divided into deceleration through the braking system and non-braking deceleration through an engine brake, and the ESC system 100 may divide a braking state of the vehicle as braking being achieved by the braking system through a brake pedal actuation signal (e.g., brake lamp signal (BLS)).

In various embodiments of the present invention, the ESC system 100 recognizes that the braking is achieved through such a configuration, and calculates and accumulates the abrasion index every braking and compares the calculated and accumulated abrasion index with the predetermined reference value to estimate the replacement timing of the brake friction pad.

In some embodiments, the reference value may be calculated through evaluation performed under a dynamo environment for evaluating abrasion performance when the brake friction pad is developed in a vehicle developing step and may vary depending on a vehicle to which the technology of the present invention is applied.

Since the ESC system 100 may not accurately judge a replacement cycle of the brake friction pad only by accumulating the abrasion index in braking, which is recognized by using the wheel speed sensor 10 in calculating the abrasion index to judge the replacement timing of the brake friction pad, the ESC system 100 of the present invention is configured to improve accuracy of the judgment of the replacement cycle of the brake friction pad in association with various devices provided in the vehicle.

In general, the dynamics of the braking state may vary depending on a brake operation of the driver and a braking environment, and as a result, the ESC system 100 is configured to detect the magnitude of the braking pressure in braking through the pressure sensor 20 incorporated in an ESC modulator system in order to reflect the dynamics of the braking state to the calculation of the abrasion index, and calculate and accumulate the abrasion index in proportion to the detected magnitude of the braking pressure.

Since a brake friction pad is a system having a strong chemical property, which operates to be very sensitive to a vehicle load, a travelling condition, and a surrounding environmental temperature/humidity, the ESC system 100 of the present invention is configured to add and apply a weight through a configuration described below to the abrasion index in addition to the basically calculated abrasion index.

The word ‘weight’ is used herein to represent “a value for reflecting a situation when calculating and accumulating the abrasion index, in which abrasion is made more than a normal abrasion amount of the brake friction pad which occurs in normal travelling ” in the specification of the present invention and a value of the weight may be set by an experiment or a test performed in advance. Weights of various situations described below follows the above definition.

First, the ESC system 100 is connected with the suspension link height sensor 30 mounted in an air suspension vehicle in order to receive front/rear wheel load state information of the vehicle, and receives the front/rear wheel load state information of the vehicle from the suspension link height sensor 30 and uses the received front/rear wheel load state information as the weight to calculate the abrasion index. In this case, in some embodiments, it is preferable that the weight is set to increase as a load on the corresponding brake friction pad increases.

The ESC system 100 receives steering state information of the vehicle by being connected with the MDPS system 40 of the vehicle in order to receive uneven abrasion available state information of a brake disk by wheel lateral force when the vehicle is turned or receives yaw rate information by being connecting with the YAW-G sensor 41 provided in the vehicle to use the steering state information of the vehicle and the yaw rate information for calculating the abrasion index. In this case, in some embodiments, it is preferable that the weight added to the abrasion index is increases when the wheel lateral force applied to the corresponding brake friction pad increases by a vehicle steering state or a yaw rate increases.

The ESC system 100 is connected with the vehicle outdoor temperature sensor 50 in order to receive a surrounding temperature when the vehicle travels and receives information of the vehicle outdoor temperature sensor 50 to use the received information for calculating the abrasion index of the brake friction pad. In this case, in some embodiments, it is preferable to increase the weight added to the abrasion index as an outdoor temperature increases because the brake friction pad is more abraded at a high temperature.

The ESC system 100 may be configured to consider humidity in calculating the abrasion amount of the brake friction pad and to this end, the ESC system 100 is connected with the rain sensor 60 or a vehicle body control unit to receive operation information of the wiper. Usually, the humidity may exert a large influence on the abrasion of the brake friction pad under an environment in which the friction occurs and in particular, the abrasion of the friction pad may be largely influenced in a travelling condition state in the case of rain, and as a result, the weight is increased as the humidity increases by judging a vehicle travelling surrounding environment state through information of the rain sensor 60 or the wiper operation information to be reflected to the abrasion index of the brake friction pad.

Hereinafter, the configuration of the present invention will be described in detail with reference to Equation 1 and Equation 2.

As described above, the ESC system 100 is configured to calculate the abrasion amount of the brake friction pad by judging whether the vehicle is in a deceleration mode.

In the deceleration mode as an item determined through evaluation and tuning in a vehicle developing step, evaluation is usually performed under a Dynamo environment for evaluating the abrasion performance in developing the brake friction pad in the vehicle developing step or stage and in this case, an initial vehicle speed is set and the abrasion performance is verified through repeated braking for each deceleration speed. The evaluation may be performed by adding a surrounding environment condition such as a hot rolling mode or a cold rolling mode. The ESC system 100 of the present invention may more accurately predict the abrasion amount of the brake friction pad by using evaluation data achieved in a friction pad developing step.

Whether the vehicle is in a deceleration mode in the ESC system 100 is judged through the pressure sensor 20 incorporated in the ESC system 100 and such a process will be described below.

First, the ESC system 100 divides a deceleration state of the vehicle into 1 to N steps or modes according to a logic development concept. For example, when the deceleration state is divided and made to a mode at a deceleration interval of 0.1 g, it is judged that a maximum deceleration speed is usually 1.0 g, and as a result, the deceleration state is divided into 10 deceleration state modes and when the deceleration state is divided at an interval of 0.05 g, the deceleration state is divided into a total of 20 deceleration state modes.

The number of N may be adjusted according to the maximum deceleration logic development concept and as the size of N is larger, it may be judged that more precise prediction is available.

An abrasion degree of the friction pad in braking in each deceleration mode varies. Low deceleration and high deceleration may be different in abrasion degree of the friction pad.

While the low deceleration mode is set to 1, as a meter number mode becomes larger, the mode is defined as the high deceleration (mode N may be considered as a maximum deceleration mode).

When data that the thickness of the friction pad reaches an abrasion warning level after the braking is performed Al times in the repeated braking only in the case of mode 1 and the thickness of the friction pad reaches the abrasion warning level after the braking is performed A2 times in the repeated braking only in the case of mode 2 is calculated through advance Dynamo evaluation, a value of the A2 is smaller than that of the A1, herein. Since the mode 2 is the high deceleration, the number of braking times cannot but be smaller than that in the mode 1. In this case, when the mode 2 is compared with the mode 1 in terms of the same repetition times, the abrasion index may be granted. For example, when the value of the A2 is at a level of 90% of the value of the A1, in the mode 2, the thickness may reach an abrasion reference at the level of 90% of the number of braking times in the mode 1. As the concept, in mode 3, the number of repeated braking times of an abrasion reference reaching condition is A3, in mode 4, the number of repeated braking times is A4, and in mode N, the number of repeated braking times is AN, the thickness reaches the friction pad abrasion reference.

In this case, the magnitudes of the values are A1>A2>A3> . . . >AN.

When a predetermined set value of the brake friction pad is Z (in some embodiments, it is preferable that Z is usually set to give a warning at the time when 2 mm remains from the friction pad thickness), the abrasion index is calculated according to an equation described below.

[(Z/A₁)×the number of occurrence times of mode 1]+[(Z/A₂)×the number of occurrence times of mode 2]+ . . . +[(Z/A_{N})×the number of occurrence times of mode N]>Z (e.g., abrasion SPEC) Equation 1:

When the number of occurrence for each mode is defined as Pₖ

$${\sum }_{k = 1}^{n} \frac{Z}{{A}_{k}} {P}_{k} > Z .$$

The calculation of the abrasion index of the Equation 1 may be applied by granting the weight according to the traveling environment condition of the vehicle as described above. An equation estimated with the basic number of abrasion times for each deceleration mode in a cool rolling state (e.g., room temperature condition) configures logic according to a concept of Equation 1 and the weight may be reflected on a logic equation by measuring an abrasion index in the hot rolling state through vehicle outdoor temperature information and the number of repeated braking times for each time interval. When it is assumed that in the hot rolling state, 110% of abrasion occurs as compared with abrasion in the cool rolling state, a weight of 1.1 may be granted.

Granting an additional weight between front and rear wheels is additionally required herein. A load moves to the front wheel in braking and a load movement amount varies depending on the deceleration speed.

Each load movement amount may be reviewed through a braking performance theoretical equation and even though the same deceleration speed is generated, the weight depending on the load needs to be additionally granted to the front wheel as compared with the rear wheel.

In addition, a weight granting concept may be additionally granted according to a vehicle option. A difference weight between inner and outer wheels is required in quick turning travelling or braking and weights depending on front and rear wheel weights may be additionally granted through the suspension link height sensor. Even a weight may be granted in a rainy day (humid condition) through the rain sensor or the wiper operation information. Further, when a downhill braking condition is recognized through the YAW-G sensor 41, additional movement may occur as compared with the existing front wheel load movement amount, and as a result, a weight in a downhill braking state may also be granted.

When the abrasion index finally accumulatively calculated by adding the weight depending on the vehicle traveling environment recognized from the respective means to accumulative calculation of the abrasion index is more than a predetermined set value, a guidance message is output through a cluster 200 to allow the driver to recognize the friction pad replacement timing.

When the weights calculated from the respective means are defined as W1, W2, W3, . . . , Wm, if a total accumulation value of the abrasion index including the weight for each means is larger than a predetermined set value, the abrasion warning is displayed, and as a result, replacement of the brake friction pad may be induced and such a configuration follows an equation described below.

$$[ {W}_{1} \times {\sum }_{k = 1}^{n} \frac{Z}{{A}_{k}} {P}_{k} ] + [ {W}_{2} \times {\sum }_{k = 1}^{n} \frac{Z}{{A}_{k}} {P}_{k} ] + … + [ Wm \times {\sum }_{k = 1}^{n} \frac{Z}{{A}_{k}} {P}_{k} ] > Z \\ {\sum }_{i = 1}^{m} {W}_{i} [ {\sum }_{k = 1}^{n} \frac{Z}{{A}_{k}} {P}_{k} ] > Z \qquad Equation 2$$

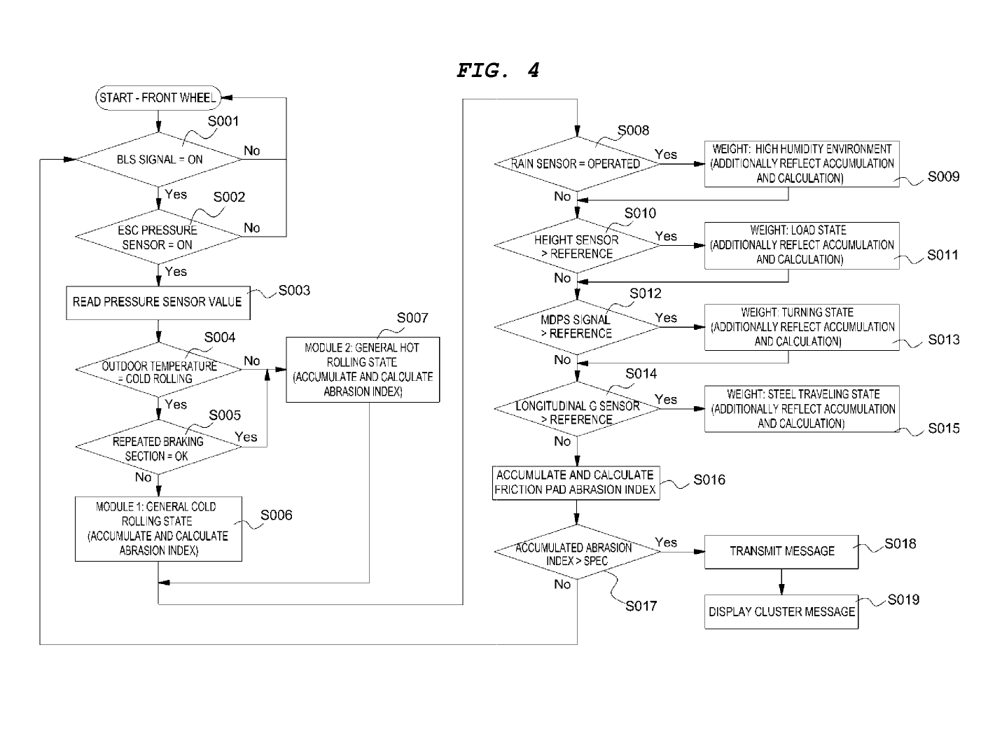

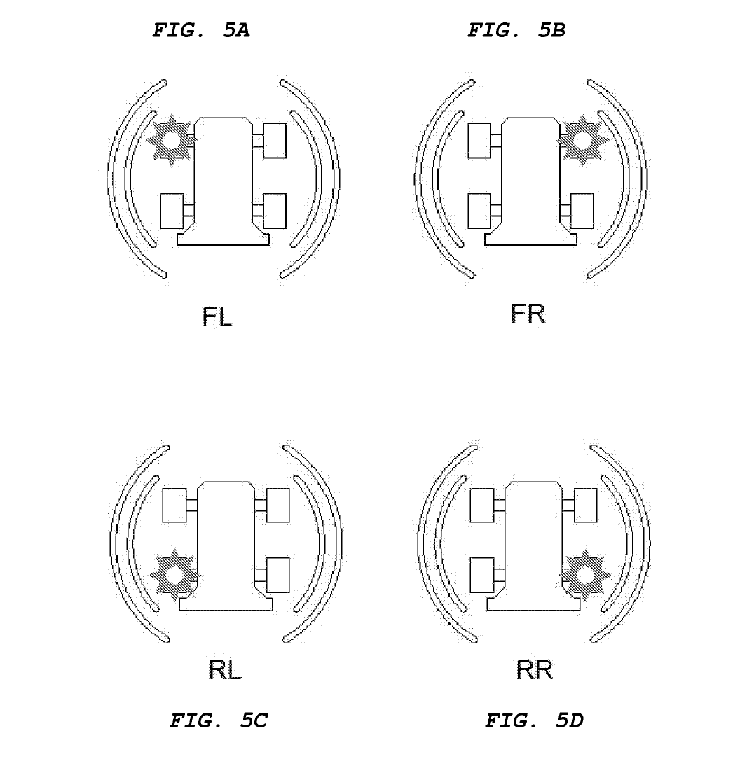

FIG. 4 is a flowchart illustrating a process of calculating an abrasion amount of the brake friction pad of the ESC system 100 according to various embodiments of the present invention and illustrates calculating an abrasion amount of a predetermined brake friction pad (e.g., a brake friction pad of the front left wheel of the vehicle) among brake friction pads provided in the vehicle.

FIG. 4 illustrates a process of calculating an abrasion amount of a front left wheel of the vehicle as an example, but abrasion amounts of a front right wheel and rear left and right wheels of the vehicle may also be calculated through the same process and such a configuration is just a part achieved by applying the same configuration to each part and a detailed description thereof will be skipped.

First, the ESC system 100 monitors an input of a brake pedal and judges whether the brake pedal is input through a brake lamp signal (BLS), after an initial start (S001). In monitoring the brake lamp signal, since the deceleration of the vehicle includes both a case of deceleration through the braking system and a case of non-braking deceleration through the engine brake, the ESC system 100 monitors the input of the brake pedal to recognize braking deceleration.

When the ESC system 100 recognizes that the brake pedal is operated and braking deceleration is achieved by receiving the BLS through step S001, the ESC system 100 judges whether the pressure sensor 20 included in the ESC system 100 is operated (S002). Since the dynamics of the braking state varies depending on the brake operation of the driver and the braking environment as described above, the pressure sensor 20 receives the braking pressure in order to recognize a difference in the dynamics of the braking state.

The ESC system 100 recognizes the difference in the dynamics of the braking state by receiving the braking pressure measured from the pressure sensor 20 when judging that the pressure sensor 20 is operated through step S002 (S003).

Meanwhile, the ESC system 100 receives the outdoor temperature information of the vehicle through the vehicle outdoor temperature sensor 50 and judges whether a received outdoor temperature of the vehicle is in the cold rolling state (e.g., room temperature condition) (S004). This step is performed because a difference in the abrasion amount of the brake friction pad occurs depending on the outdoor temperature.

When it is judged that the outdoor temperature of the vehicle is in the cool rolling state in step S004, the ESC system 100 recognizes the number of braking state times by receiving the brake lamp signal (BLS) from the brake system of the vehicle and preferentially judges whether a current section is a section where repeated braking is performed, prior to regarding that a current vehicle travels in the cold rolling state (S005).

In this case, the ESC system 100 may count the number of braking times performed within a predetermined set time (predetermined time) in judging the repeated braking and judge that the repeated braking is performed when the number of braking times within the set time is more than the specific number of times.

In the above step, the reason why the ESC system 100 judges the repeated braking or not is that it is deduced in previously performed abrasion performance evaluation that when the repeated braking is performed in the vehicle which travels in the cold rolling state, the brake friction pad reaches an abrasion reference similar to a state of the vehicle which travels in the hot rolling state.

In step S005, the ESC system 100 is configured to grant the weight in calculating the abrasion index when judging that the repeated braking is performed at present (S007). In this case, the added weight may be the same as the granted weight to the vehicle which travels in the hot rolling state and a detailed matter thereof will be described below.

However, in step S005, the ESC system 100 regards that the vehicle travels currently in the cold rolling state (e.g., room temperature condition) when judging the current section is not the repeated braking section and in step S003, the ESC system 100 calculates and accumulates the abrasion index without adding the weight depending on the outdoor temperature in proportion to the braking pressure measured from the pressure sensor 20 (S006). It is described that the weight depending on the outdoor temperature is not granted to the vehicle which travels in the cold rolling state in step S006 as an example, but the present invention is not limited thereto and a specific weight may be granted if desired.

On the contrary, when it is judged that the outdoor temperature of the vehicle is not in the cold rolling state in step S004 or when it is judged that the repeated braking is performed in step S005, the ESC system 100 judges that the vehicle travels currently in the hot rolling state.

The ESC system 100 calculates the abrasion index in proportion to the braking pressure measured from the pressure sensor 20 in step S003, and in this case, calculates and accumulates the abrasion index by granting the weight depending on the outdoor temperature (S007).

In granting the weight depending on the outdoor temperature, since the friction pad of the brake pad is usually abraded more in the hot rolling state than the cold rolling state, the abrasion index calculated in the hot rolling state needs to be set to be larger than the abrasion index calculated in the cold rolling state. Accordingly, as described above, the abrasion index is preferably calculated by granting the weight depending on the outdoor temperature to the abrasion index calculated in the hot rolling state and besides, in another exemplary embodiment of the present invention, the weights are granted to the abrasion indexes calculated in the hot rolling state and the cold rolling state, respectively and in this case, the weight in the hot rolling state may be set to be larger than the weight in the cold rolling state.

In various embodiments of the present invention, in calculating the abrasion index in the hot rolling traveling mode, a weight calculated according to a previously measured result may be granted and for example, when it is measured that abrasion measured when the vehicle travels in the hot rolling state is 110% of the abrasion measured when the vehicle travels in the cold rolling state, the weight may be granted so that the abrasion index in the hot rolling traveling is increased to be 1.1 times larger than the abrasion index in the cold rolling traveling.

Meanwhile, the ESC system 100 judges that the vehicle is in a traveling state in the case of rain from the rain sensor or judges that the vehicle is in the traveling state in the case of rain by receiving the wiper operation information from the vehicle body control unit in link with the rain sensor and/or the vehicle body control unit previously provided in the vehicle so as to calculate the abrasion index of the brake friction pad by reflecting humidity (S008).

In step S008, the ESC system 100 judges that the vehicle travels currently under a high humidity environment when judging that the vehicle travels in the case of rain and a weight depending on the case of rain is granted to the abrasion index set in step S006 or S007 (S009). In this step, since the brake friction pad is usually abraded larger in the case of rain, the weight is granted to the abrasion index to reflect humidity to the calculation of the abrasion index of the brake friction pad.

The ESC system 100 receives information of the suspension link height sensor 30 through the suspension link height sensor 30 and judges load states of the front and rear wheels of the vehicle therethrough (S010). In this step, the ESC system 100 grants the weight depending on the load to the abrasion index in proportion to a load at a corresponding position to set the current abrasion index of the brake friction pad, in other words, the load applied to the front left wheel in the exemplary embodiment as an example.

Usually, since the brake friction pad at the side to which the load is applied is more abraded than the brake friction pad to which the load is not applied, the weight is granted to the abrasion index when it is judged that the load applied to the corresponding brake friction pad is more than a usual range in step S010 (S011).

The ESC system 100 receives steering information from the MDPS system 40 in link with the MDPS system 40 and judges a vehicle turning state therethrough (S012).

In this step, different loads are applied to respective parts of the vehicle by wheel lateral force according to the vehicle turning state, and as a result, the ESC system 100 may cope with a one-side abrasion phenomenon in which brake pads of the respective front and rear wheels and left and right wheels of the vehicle are abraded differently from each other.

A weight depending on the turning state is granted to the abrasion index in proportion to respective loads at corresponding positions to set the current abrasion index of the brake friction pad according to the vehicle turning state, in other words, the load applied to the front left wheel in the exemplary embodiment.

As described above, since the brake friction pad at the side to which the load is applied is abraded relatively more than a brake friction pad at a side to which the load is less applied, the ESC system 100 grants the weight to the abrasion index when judging the load applied to the corresponding brake friction pad is more than the usual range according to the vehicle turning state in step S012 (S013).

The ESC system 100 receives information from the longitudinal g sensor 41 in link with the longitudinal g sensor 41 of the vehicle and judges whether the vehicle is currently in a steel traveling state therethrough (S014).

In this step, the ESC system 100 grants the weight depending on the steel traveling or not to the abrasion index in proportion to the load increased according to the steel traveling or not because a load applied to a predetermined brake friction pad to accumulate and calculate a current abrasion index, in other words, the load applied to the front left wheel in the exemplary embodiment may be increased.

Accordingly, when it is judged that the load applied to the corresponding brake friction pad is more than the usual range according to the steel traveling in step S014, the weight is granted to the abrasion index (S015).

The ESC system 100 accumulates and calculates the abrasion index by reflecting the weights granted through the steps (S016) and compares the calculated abrasion index with a predetermined set value (S017). The set value, as a value set by the abrasion performance evaluation of the brake friction pad performed previously, may be a value acquired while the brake friction pad is abraded enough to be replaced through a test.

Accordingly, when the abrasion index accumulated through steps S001 to S015 is more than the set value, it may be judged that the brake friction pad at the corresponding position is abraded enough to be replaced. The abrasion index and the set value are deduced and set by the abrasion performance evaluation of the brake friction pad.

The ESC system 100 generates and outputs a notification message when judging that the abrasion index is more than the set value in step S016 (S018) and the notification message is transmitted to the cluster 200 of the vehicle to be displayed to inform or induce the driver to replace the corresponding brake friction pad (S019).

FIGS. 5A-5D illustrate examples of a notification message displayed on a cluster of a vehicle to inform a brake friction pad replacement timing. As described above, the ESC system of the present invention is configured to calculate abrasion indexes for respective brake friction pads such as four respective brake friction pads provided in the vehicle, respectively and generate notification messages therefor, respectively to be transmitted to the cluster 200.

Therefore, the cluster 200 of the vehicle is configured to display to the driver a specific brake friction pad which needs to be replaced by receiving the notification message from the ESC system and this configuration may be represented as illustrated in FIGS. 5A-5D in which the respective brake friction pads provided at FR, FL, RR, and RL wheels of the vehicle are simplified.

Accordingly, the driver who drivers the vehicle to which the present invention is applied may easily recognize a replacement timing of a specific brake friction pad of the vehicle through the figure displayed in the cluster.

For convenience in explanation and accurate definition in the appended claims, the terms “front” or “rear”, “left” or “right”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for abrasion warning of a brake friction pad of a vehicle comprising:
a friction pad abrasion sensing system (ESC) including a pressure sensor, wherein the ESC system:
recognizes a speed change in association with a wheel speed sensor of the vehicle,
measures a braking pressure using the pressure sensor included in the ESC system when the vehicle is decelerated,
calculates and accumulates an abrasion index proportional to the measured braking pressure, and
generates and outputs a notification message when the accumulated abrasion index is more than a predetermined reference value.

2. The system of claim 1, wherein the ESC system further:
receives vehicle outdoor temperature sensor information from a vehicle outdoor temperature sensor, and
grants and applies a first weight to calculation of the abrasion index if it is judged that a vehicle outdoor temperature is in a hot rolling state.

3. The system of claim 1, wherein the ESC system further:
receives at least one of a rain sensor signal from a rain sensor and a wiper operation signal from a vehicle body control unit, and
grants and applies a second weight to the calculating of the abrasion index in accord with the received rain sensor signal or the received wiper operation signal or both.

4. The system of claim 1, wherein the ESC system further:
receives at least one of a steering control signal from a Motor-Driven Power Steering (MDPS) system and yaw sensor information from a YAW sensor,
judges if the vehicle is turned based on the received steering control signal or the YAW sensor information or both, and
grants and applies a third weight to the calculating of the abrasion index if it is judged that the vehicle is turned.

5. The system of claim 1, wherein the ESC system further:
receives suspension height sensor information from a suspension height sensor,
judges if a load of the vehicle increases based on the suspension height sensor information, and
grants and applies a fourth weight to the calculating of the abrasion index if it is judged that the load of the vehicle increases.

6. The system of claim 1, wherein the ESC system further:
receives longitudinal G sensor information from a longitudinal G sensor of the vehicle,
judges whether the vehicle is in a steel traveling state based on the longitudinal G sensor information, and
grants and applies a fifth weight to the calculating of the abrasion index if it is judged that the vehicle is in the steel traveling state.

7. The system of claim 1, wherein the ESC system further:
receives a brake lamp signal from a brake system of the vehicle, and
grants and applies a sixth weight to the calculating of the abrasion index if it is judged that repeated braking is performed within a set time based on the brake lamp signal.

8. A method for abrasion warning of a brake friction pad of a vehicle, wherein the method is executed by a friction pad abrasion sensing system (ESC) including a pressure sensor, the method comprising:
recognizing a speed change in association with a wheel speed sensor of the vehicle;
measuring a braking pressure using the pressure sensor included in the ESC system when the vehicle is decelerated;
calculating and accumulating an abrasion index proportional to the measured braking pressure; and
generating and outputting a notification message when the accumulated abrasion index is more than a predetermined reference value.

9. The method of claim 8, further comprising:
receiving vehicle outdoor temperature sensor information from a vehicle outdoor temperature sensor; and
granting and applying a first weight to the calculating of the abrasion index if it is judged that a vehicle outdoor temperature is in a hot rolling state.

10. The method of claim 8, further comprising:
receiving at least one of a rain sensor signal from a rain sensor and a wiper operation signal from a vehicle body control unit; and
granting and applying a second weight to the calculating of the abrasion index in accord with the received rain sensor signal or the received wiper operation signal or both.

11. The method of claim 8, further comprising:
receiving at least one of a steering control signal from a Motor-Driven Power Steering (MDPS) system and yaw sensor information from a YAW sensor;
judging if the vehicle is turned based on the received steering control signal or the YAW sensor information or both; and
granting and applying a third weight to the calculating of the abrasion index if it is judged that the vehicle is turned.

12. The method of claim 8, further comprising:
receiving suspension height sensor information from a suspension height sensor;
judging if a load of the vehicle increases based on the suspension height sensor information; and
granting and applying a fourth weight to the calculating of the abrasion index if it is judged that the load of the vehicle increases.

13. The method of claim 8, further comprising:
receiving longitudinal G sensor information from a longitudinal G sensor of the vehicle;
judging whether the vehicle is in a steel traveling state based on the longitudinal G sensor information; and
granting and applying a fifth weight to the calculating of the abrasion index if it is judged that the vehicle is in the steel traveling state.

14. The method of claim 8, further comprising:
receiving a brake lamp signal from a brake system of the vehicle; and
granting and applying a sixth weight to the calculating of the abrasion index if it is judged that repeated braking is performed within a set time based on the brake lamp signal.
